(19) United States
(12) Patent Application Publication
(10) Pub. No.: US 2024/0325800 A1
(43) Pub. Date: Oct. 3, 2024

(54) PORTABLE FIRE BLANKET DEPLOYMENT SYSTEM AND METHOD

(71) Applicant: Saudi Arabian Oil Company, Dhahran (SA)

(72) Inventors: Abdulwahab HALAWANI, Dhahran (SA); Ahmed AL BRAHIM, Dhahran (SA); Hassane TRIGUI, Dhahran (SA)

(21) Appl. No.: 18/194,688

(22) Filed: Apr. 3, 2023

(51) Int. Cl. A62C 3/02; A62C 8/06; A62C 27/00

(52) U.S. Cl. CPC A62C 3/0257; A62C 8/06; A62C 27/00

(57) ABSTRACT

A portable system and method deploy a fire blanket to extinguish fires. One embodiment includes a foldable hinged assembly of arc-shaped elongated members configured to retain a fire blanket over a fire, and to pivot the arc-shaped elongated members to move the fire blanket onto the fire to smother and extinguish the fire. Another embodiment has a fire blanket mounted on poles of mobile platforms which are positionable to surround the fire and drop the fire blanket onto the fire to smother and extinguish the fire. Methods implement the portable system of the disclosed embodiments.

### FIELD OF THE DISCLOSURE

The present disclosure relates generally to fire blankets to extinguish fires, and, more particularly, to a portable fire blanket deployment system and method.

### BACKGROUND OF THE DISCLOSURE

Extensive and large fire situations, such as at oil and gas facilities, can put firefighters in danger when battling, containing, and extinguishing such fire situations. Fire blankets composed of fire-resistant materials are used to extinguish fires, but the manual deployment of fire blankets can still endanger the firefighters trying to deploy the fire blankets.

### SUMMARY OF THE DISCLOSURE

According to an embodiment consistent with the present disclosure, a portable system and method deploy a fire blanket to extinguish fires.

In an embodiment, a system is configured to extinguish a fire, with the system comprising a fire blanket, a plurality of elongated members coupled to the fire blanket, and a plurality of hinges, with each hinge pivotally coupling respective pairs of the plurality of elongated members. The plurality of elongated members are configured to lie horizontally on the ground surrounding the fire in a first configuration. In a second configuration, a first opposing pair of elongated members are pivotable about the plurality of hinges with respect to a second opposing pair of elongated members to orient the first opposing pair vertically. The vertically oriented first opposing pair retain the fire blanket above the fire in the second configuration. The vertically oriented first opposing pair are pivotable to be oriented horizontally to return the plurality of elongated members to lie horizontally on the ground in the first configuration. Responsive to any pivoting of the vertically oriented first opposing pair back to the first configuration, the fire blanket moves to a position over the fire, proximate to the ground, thereby smothering and extinguishing the fire.

A set of the plurality of elongated members can be arc-shaped. With the plurality of elongated members in the first configuration, the set of arc-shaped elongated members can be in a circular configuration surrounding the fire. The system further comprises a cable coupled to the fire blanket, and a winch disposed on the ground and configured to pull the cable along at least a first elongated member of the first opposing pair of elongated members in the second configuration, thereby deploying the fire blanket to be retained by the vertically oriented first opposing pair.

In another embodiment, a system is configured to extinguish a fire, with the system comprising a fire blanket, a plurality of mobile platforms, a plurality of poles each extending vertically from a respective mobile platform, and a plurality of cables. Each pole is coupled to the fire blanket by a respective cable. The plurality of mobile platforms are movable to respective locations to surround the fire. Each pole is configured to raise the fire blanket above the fire. The fire blanket is vertically lowerable to cover the fire, thereby smothering and extinguishing the fire.

Each pole can include a base member and a telescoping member movable vertically in the base member in a telescoping configuration. Each mobility platform can include a wheel. Each mobility platform can include ground lock member configured to lock the respective mobile platform in the respective geographic location. A plurality of caps can each be disposed at a top of a respective pole, and plurality of retaining members can be coupled to a respective cable. Each cap retains a respective retaining member at the top of the respective pole. Movement of each cap releases the respective retaining member, thereby letting the respective cable loose to lower the fire blanket by gravity. The movement of each cap can include jettisoning each cap from the top of each respective pole. Alternatively, the movement of each cap includes retracting each cap into the top of each respective pole.

The system can also include a plurality of mounting brackets with each bracket connected to the fire blanket by a respective cable, a plurality of lines with each line connected to a mounting bracket, and a plurality of pulleys with each pulley configured to move each respective line vertically. Each pulley is associated with a respective pole, and each pulley is configured to raise or lower the fire blanket vertically by raising or lowering each respective line.

In a further embodiment, a method is configured to extinguish a fire, comprising raising a fire blanket on a plurality of poles on respective mobility platforms, positioning the plurality of mobility platforms around the fire, lowering the fire blanket onto the fire, and smothering the fire using the fire blanket, thereby extinguishing the fire. The method can further comprise raising the fire blanket after the fire is extinguished. The raising of the fire blanket can include raising the fire blanket using a plurality of pulley systems each attached to a respective pole. Alternatively, the raising of the fire blanket can includes extending a telescoping member of each pole vertically.

The method can further comprise disposing a plurality of caps at a top of each respective pole, and retaining a plurality of cables at a top of each respective pole using a respective cap holding a respective retaining member, with each cable attached to the fire blanket by the respective retaining member. Each respective retaining member can be released by jettisoning each respective cap from the top of each respective pole. Alternatively, each respective retaining member can be released by retracting each respective cap into the top of each respective pole.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a top view of a portable fire blanket deployment system in a first configuration, according to an embodiment.

FIG. 2 is a top front side perspective view of the portable fire blanket deployment system of FIG. 1 in the first configuration.

FIG. 3 is an enlarged view of a portion of the portable fire blanket deployment system of FIG. 2.

FIG. 4 is a top front side perspective view of the portable fire blanket deployment system of FIG. 1 in a second configuration.

FIG. 5 is an enlarged view of a portion of the portable fire blanket deployment system of FIG. 4.

FIG. 6 is a top front side perspective view of the portable fire blanket deployment system of FIG. 1 in the first configuration deployed to surround a fire.

FIG. 7 is a top front side perspective view of the portable fire blanket deployment system of FIG. 1 in the second configuration deployed to surround the fire.

FIG. 8 is a top front side perspective view of the portable fire blanket deployment system of FIG. 1 in a third configuration deployed to surround the fire.

FIG. 9 is a top front side perspective view of the portable fire blanket deployment system of FIG. 1 in a fourth configuration deployed to surround the fire.

FIG. 10 is a top front side perspective view of the portable fire blanket deployment system of FIG. 1 in a fifth configuration smothering the fire.

FIG. 11 is a flowchart of operation of the portable fire blank deployment system of FIGS. 1-10.

FIG. 12 is a top front side perspective view of an alternative embodiment of the portable fire blanket deployment system.

FIG. 13 is a top portion of the portable fire blanket deployment system of FIG. 12.

FIG. 14 is a bottom portion of the portable fire blanket deployment system of FIG. 12.

FIG. 15 is a top front side perspective view of the portable fire blanket deployment system of FIG. 12 in a first configuration near equipment.

FIG. 16 is a top front side perspective view of the portable fire blanket deployment system of FIG. 12 in a second configuration.

FIG. 17 is a top front side perspective view of the portable fire blanket deployment system of FIG. 12 in a third configuration.

FIG. 18 is an enlarged view of the top portion of the portable fire blanket deployment system of FIG. 13 before release of the fire blanket.

FIG. 19 is an enlarged view of the top portion of the portable fire blanket deployment system of FIG. 13 after release of the fire blanket.

FIG. 20 is a top front side perspective view of the portable fire blanket deployment system of FIG. 12 in a fourth configuration after release of the fire blanket.

FIG. 21 is a top front side perspective view of the portable fire blanket deployment system of FIG. 12 in a fifth configuration with the fire blanket smothering the equipment.

FIG. 22 is a top front side perspective view of another alternative embodiment of a portable fire blanket deployment system in a first configuration.

FIG. 23 is a top front side perspective view of the portable fire blanket deployment system of FIG. 22 in a second configuration positioned around equipment on fire.

FIG. 24 is a top front side perspective view of the portable fire blanket deployment system of FIG. 22 in a third configuration smothering equipment.

FIG. 25 is a flowchart of operation of the portable fire blank deployment systems of FIGS. 12-24.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a portable fire blanket deployment system and method to extinguish fires.

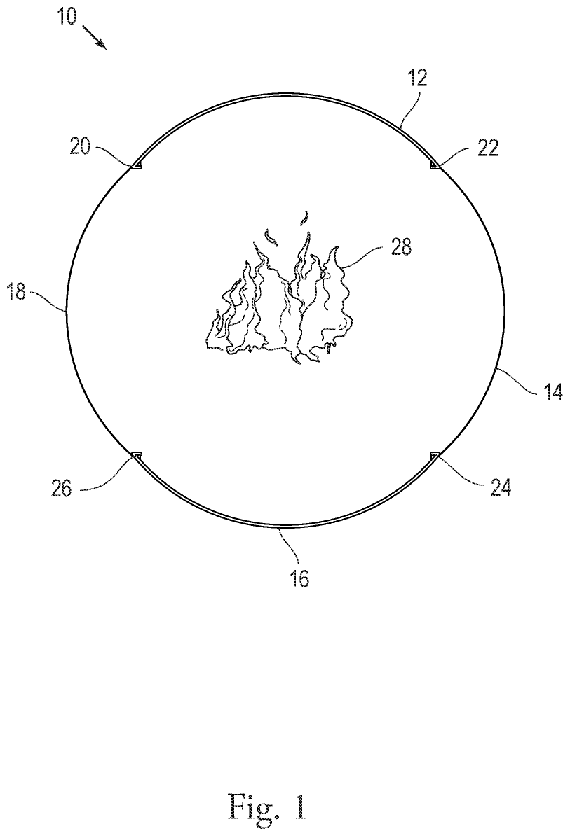

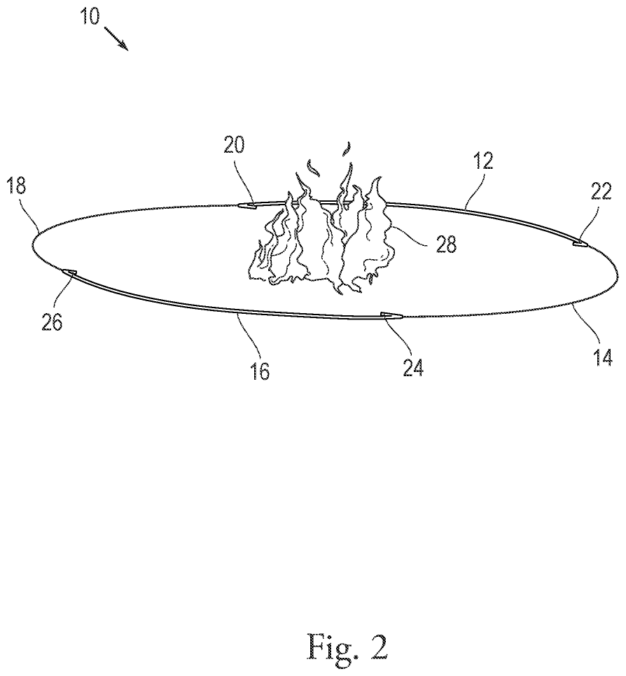

Referring to FIGS. 1-11, a portable fire blanket deployment system 10 includes a plurality of elongated members 12, 14, 16, 18 connected by hinges 20, 22, 24, 26, respectively, and forming a frame configured to surround a fire 28 to be contained or extinguished. For example, the elongated members 12, 14, 16, 18 can be arc or arc-shaped members. As shown in FIGS. 1-2, in a first initial configuration, the arcs 12, 14, 16, 18 connected by the hinges 20, 22, 24, 26 can be generally shaped in a circular configuration to surround the fire 28. The arcs 12, 14, 16, 18 can be curved. Alternatively, some or all of the arcs 12, 14, 16, 18 can be substantially linear. Accordingly, the combination of arcs 12, 14, 16, 18, being curved or linear, can form elliptical shapes, oval shapes, truncated circular shapes, triangular shapes, rectangular shapes, etc. provided that the assembled arcs 12, 14, 16, 18 can surround the fire 28.

In alternative embodiments, at least one of the arcs 12, 14, 16, 18 can have a telescoping configuration. For example, the arc 12 can be composed of a plurality of sub-arcs or rods which interconnect in a telescoping manner known in the art. Accordingly, the interconnected arcs 12, 14, 16, 18 can be extended to a desired size to completely surround the fire 28. It is important that the system 10 with interconnected arcs 12, 14, 16, 18 be of sufficient size to surround a fire 28 of any size while maintaining the safety of the firefighters deploying the system 10. In addition, by being telescoping and hinged, the system 10 can be disassembled, folded, or otherwise reconfigured by firefighters to be in a more compact configuration which can be readily transported and reassembled at another location, or transported for storage until needed again. The arcs 12, 14, 16, 18 can be composed of any known material that can sustain heat and that can structurally hold the weight of a fire blanket 44. However, the arcs 12, 14, 16, 18 are also composed of any known lightweight material to be carried and readily assembled by firefighters.

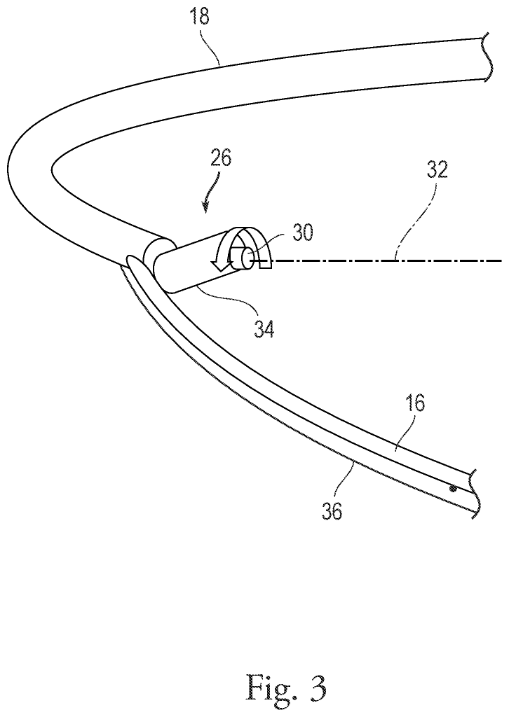

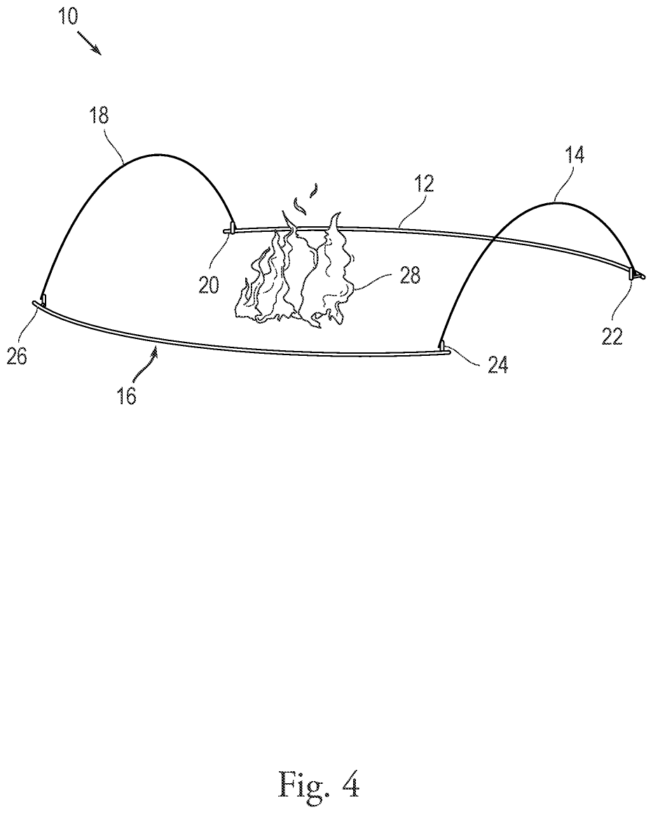

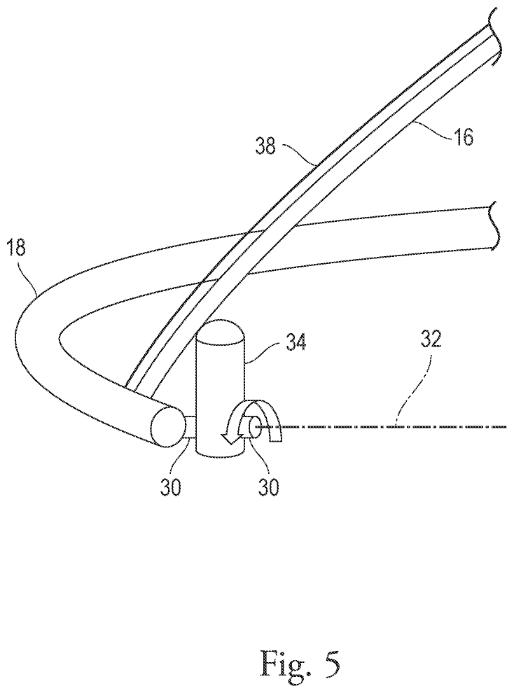

Referring back to FIGS. 1-2, the arcs 12, 16 can be primary arcs which remain horizontally on the ground, while the arcs 14, 18 can be side arcs which rotate about the hinges 20, 22, 24, 26 to be orientated in substantially vertical configurations, as shown in FIG. 4. Referring to FIGS. 3 and 5, the hinge connections between arcs are shown. For example, the arcs 16, 18 are coupled together at a hinge 26. The hinge 26 has an axle 30 with an axis of rotation 32. A member 34 acts as a hinge to connect the arcs 16, 18 together. The member 34 allows the arc 16 to rotate relative to the arc 18. The member 34 is also used to even out the frame assembly formed by the arcs 12, 14, 16, 18. A cable 38 runs along the length of the arc 16.

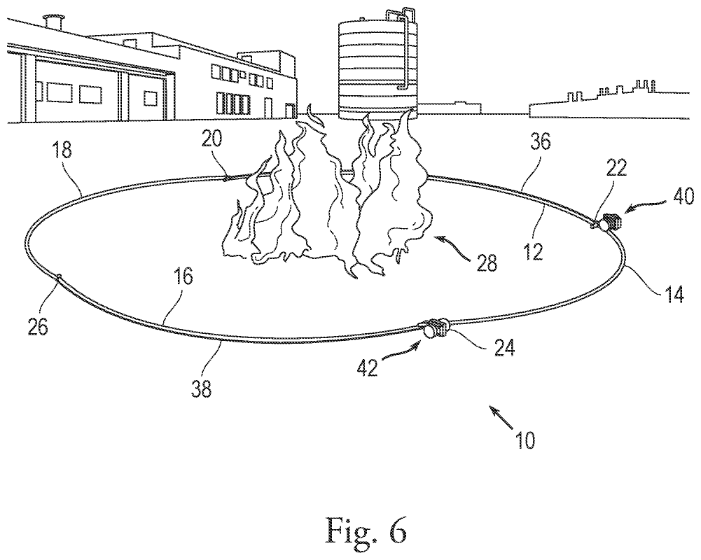

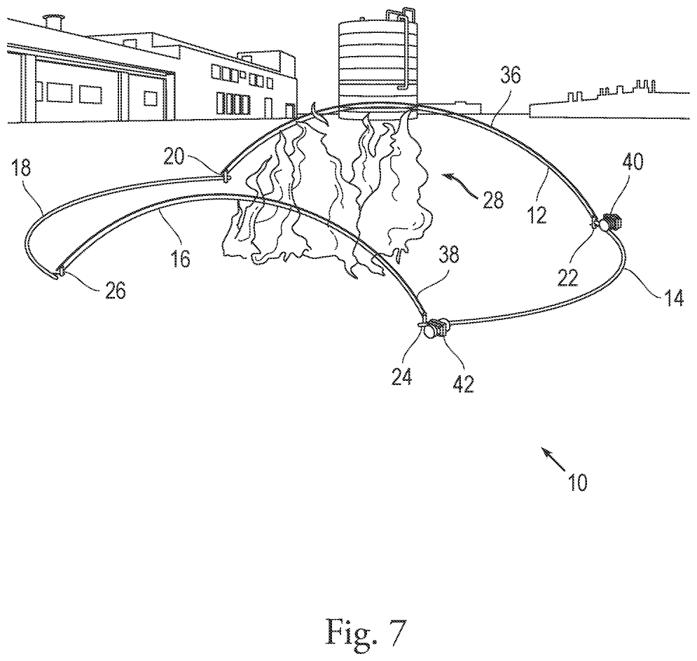

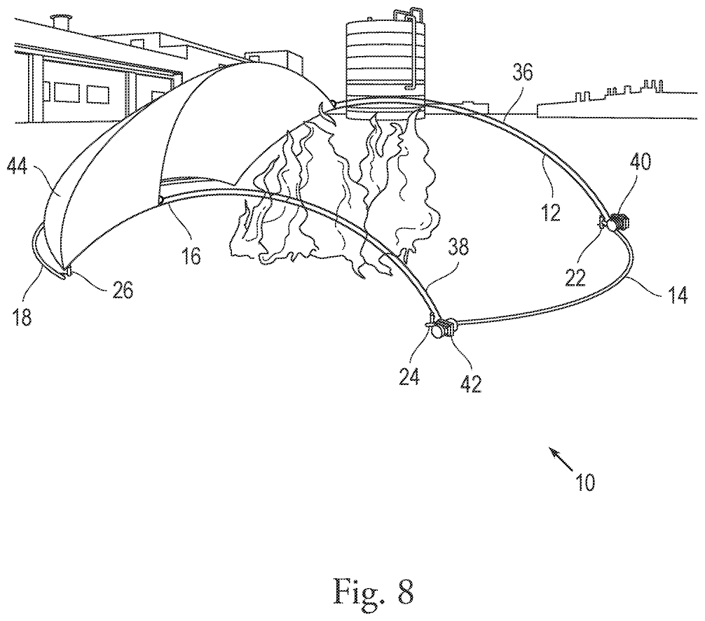

As shown in FIG. 6, the system 10 is deployed in the first configuration around a fire 28, with cables 36, 38 extending along the length of the arcs 12, 16, respectively. A pair of winches 40, 42 are positioned substantially near the hinges 22, 24, respectively. Each winch 40, 42 is configured to pull a respective cable 36, 38 along the length of the associated arcs 12, 16, respectively. As shown in FIG. 7, the arcs 12, 16 are deployed substantially vertically in the second configuration. As shown in FIG. 8, a fire blanket 44 is disposed adjacent to the arc 18, and is pulled along the length of the arcs 12, 16 by the cables 36, 38 which are reeled in by the winches 40, 42, respectively, with the arcs 12, 14, 16, 18, and hinges 20, 22, 24, 26, in the third configuration.

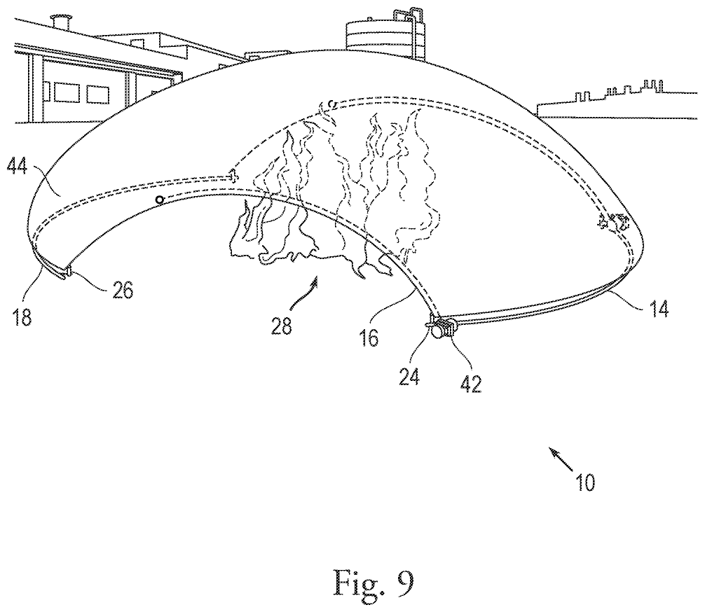

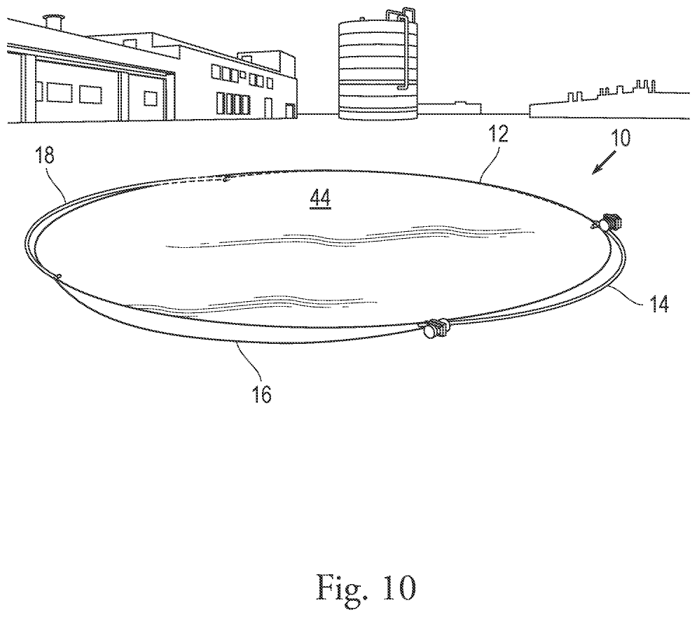

As shown in FIG. 9, the system 10 is deployed in a fourth configuration with the fire blanket 44 fully covering the fire 28. As shown in FIG. 10, the system 10 is deployed in a fifth configuration, with the arcs 12, 16 returned to the horizontal position on the ground. In turn, the fire blanket 44 is brought downward to smother and extinguish the fire 28.

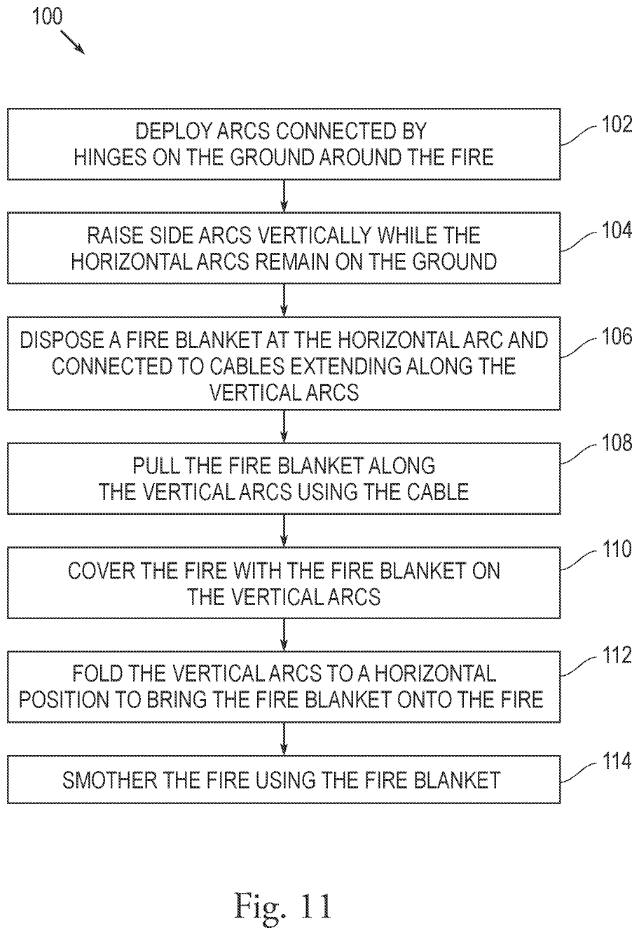

Referring to FIG. 11, a method 100 of operation of the system 10 includes the step 102 of deploying the arcs 12, 14, 16, 18 connected by the hinges 20, 22, 24, 26 on the ground around a fire 28, as shown in FIGS. 1-2 and 6. The method 100 then includes raising the side arcs 12, 16 vertically while the horizontal arcs 14, 18 remain on the ground in step 104, as shown in FIGS. 4 and 7. The method 100 then includes disposing a fire blanket 44 at one of the horizontal arcs 14, 18 and connected to cables 36, 38 extending along the vertical arcs 12, 16 in step 106, as shown in FIG. 8. The method 100 then includes pulling the fire blanket 44 along the vertical arcs 12, 16 in step 108 using the cables 36, 38 in step 110, as shown in FIGS. 8-9. The method 100 further includes covering the fire 28 with the fire blanket 44 on the vertical arcs 12, 16 in step 110, as shown in FIG. 9. The vertical arcs 12, 16 are then folded downward to a horizontal position on the ground to bring the fire blanket 44 onto the fire 28 in step 112, as shown in FIG. 10. The fire 28 is then smothered and extinguished using the fire blanket 44 in step 114, as shown in FIG. 10.

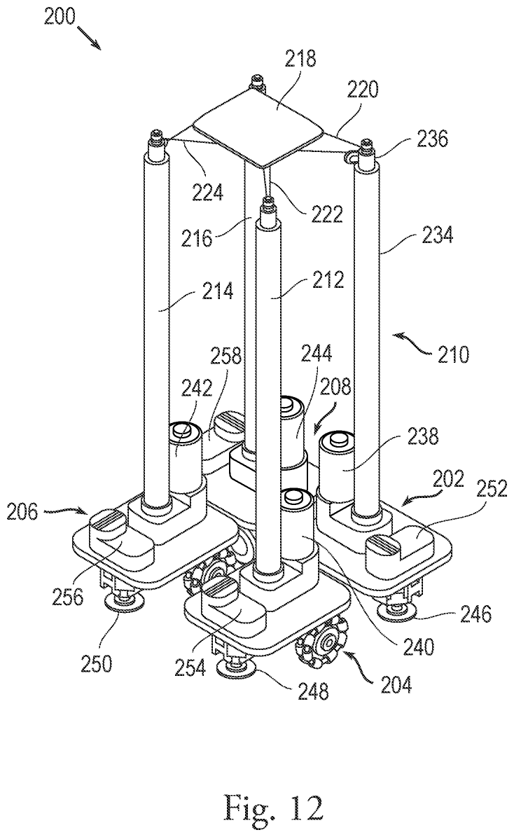

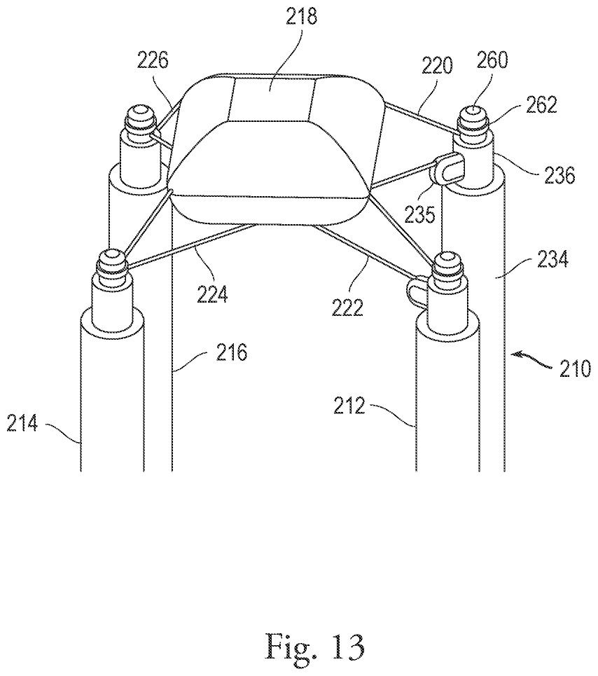

In an alternative embodiment, as shown in FIGS. 12-21, a system 200 includes a plurality of mobile platforms 202, 204, 206, 208 having poles 210, 212, 214, 216, respectively, which extend vertically. A fire blanket 218 is disposed at the top of the poles 210, 212, 214, 216, as shown in FIGS. 12-13. A plurality of cables 220, 222, 224, 226 extend from the top of the poles 210, 212, 214, 216, respectively, to be connected to the fire blanket 218. For example, the cables 220, 222, 224, 226 can be connected to corners of the fire blanket 218. Alternatively, at least one pole 210, 212, 214, 216 can be connected to a respective cable 220, 222, 224, 226 by a pulley, such as the pulley 235 in FIG. 13.

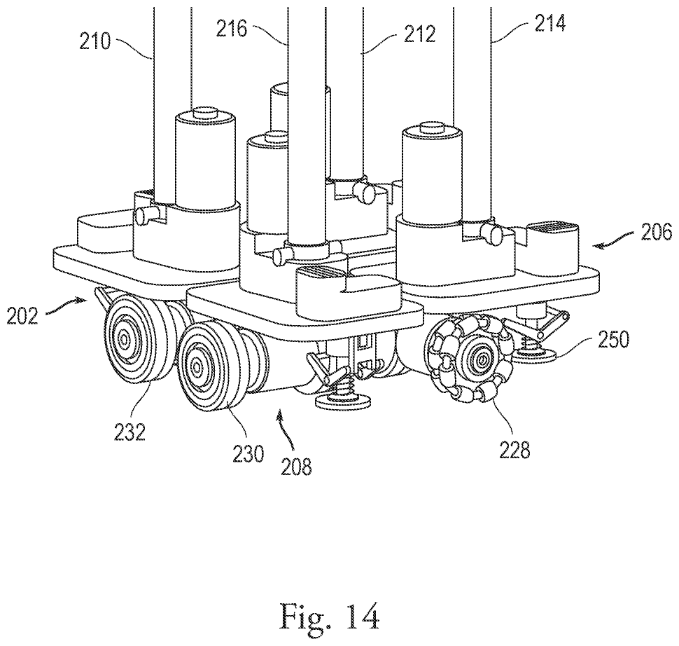

Referring to FIGS. 12 and 14, each mobile platform 202, 204, 206, 208 has a wheel, such as the example wheels 228, 230, 232 shown in FIG. 14. The wheels 228, 230, 232 are configured to move the mobile platforms 202, 204, 206, 208 to positions around a fire. The wheels 228, 230, 232 can be any known type of wheel. For example, the wheel 232 can be an omni-directional wheel, such as a mecanum wheel.

In one embodiment, the poles 210, 212, 214, 216 can be monolithic. In another embodiment as shown in FIGS. 12-13, 15-17, and 20-21, the poles 210, 212, 214, 216 can be telescopic. For example, the pole 210 has a base 234 and a telescopic member 236 which slidably engages the base 234. To control the telescoping of the poles 210, 212, 214, 216, each mobile platform 202, 204, 206, 208, respectively, has a telescoping motor 238, 240, 242, 244, respectively, as shown in FIG. 12.

Each mobile platform 202, 204, 206, 208 can also include a ground lock member, such as the ground lock members 246, 248, 250. The ground lock members can secure the mobile platforms 202, 204, 206, 208 to the ground or floor once a user determines that the poles 210, 212, 214, 216 are positioned at good geographic locations around the fire, such that the fire blanket 218 can be deployed to smother and extinguish the fire.

Each mobile platform 202, 204, 206, 208 can also include an electronics housing 252, 254, 256, 258, respectively, to control the various motors and drivers, such as the wheel drivers for the wheels 228, 230, 232, as well as the telescoping motor 238, 240, 242, 244, respectively. In one embodiment, in conjunction with the electronics in the electronics housings 252, 254, 256, 258, the user can remotely control the movement and positioning of each mobile platform 202, 204, 206, 208, and extending of the telescoping poles 210, 212, 214, 216. For example, each electronics housing 252, 254, 256, 258 can include a wireless transceiver configured to transmit and receive signals in communication with an external controller employed by the user. In another embodiment, the mobile platforms 202, 204, 206, 208 can be autonomous, and so can be configured to use the electronics to control the movement and positioning of each mobile platform 202, 204, 206, 208 as well as to control the extending of the telescoping poles 210, 212, 214, 216.

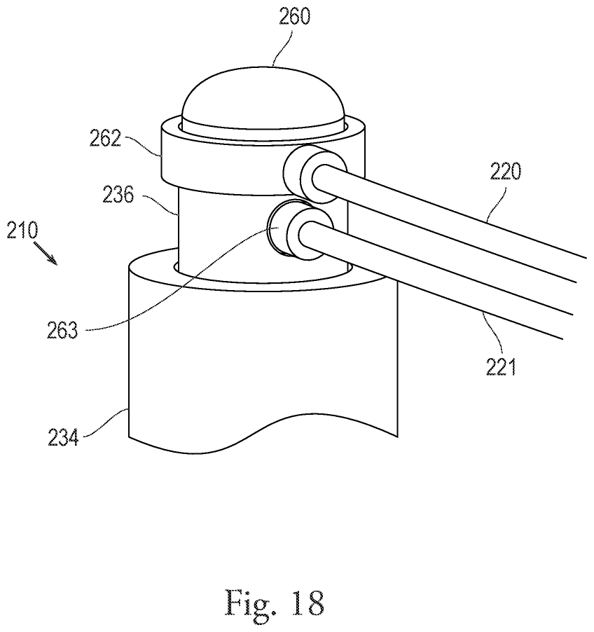

Referring to FIGS. 13 and 18, the cables 220, 222, 224, 226 can be removably mounted to the top of each respective pole 210, 212, 214, 216 using a cap, such as the cap 260. In one embodiment, for example, an end of the cable 220 includes an annular retaining member 262 which is held in place on the top of the telescoping member 236 by the cap 260. The cap 260 can be jettisoned from the telescoping member 236 to release the annular retaining member 262, and so to release the end of the cable 220. Therefore, the cable 220 becomes loose, allowing the fire blanket 218 to fall and smother the fire and any equipment below. In another embodiment, the cap 260 can be retracted into the telescoping member 236, to release the annular retaining member 262, and so to release the end of the cable 220. Therefore, the cable 220 becomes loose, allowing the fire blanket 218 to fall and smother the fire and any equipment below. The annular retaining member 262 is composed of a relatively heavy material to assist the fire blanket 218 to fall by gravity onto the fire and any equipment below.

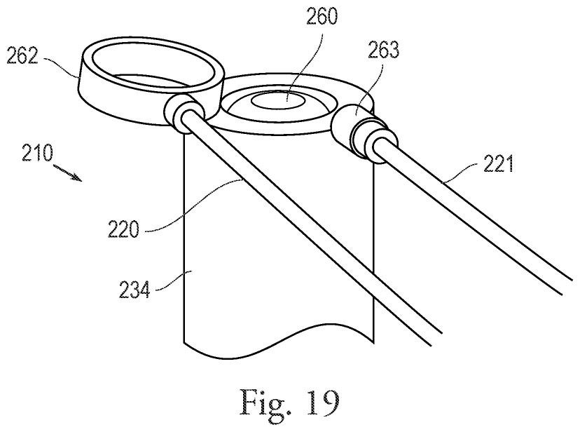

Referring to FIGS. 18-19, the base 234 and the telescoping member 236 can be composed of metal, and a second cable 221 can have a ferromagnetic tip 263 configured to be retained magnetically on the telescoping member 236 prior to retraction of the cap 260. After retraction of the cap 260, the ferromagnetic tip 263 can be retained magnetically on the base 234 of the pole 210.

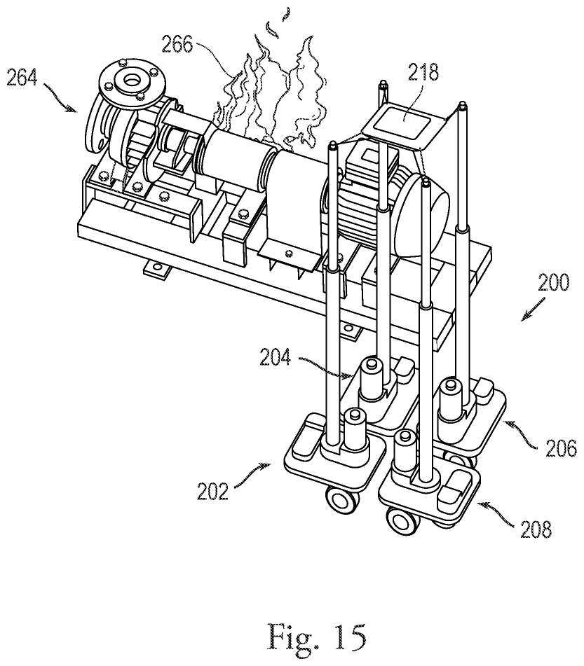

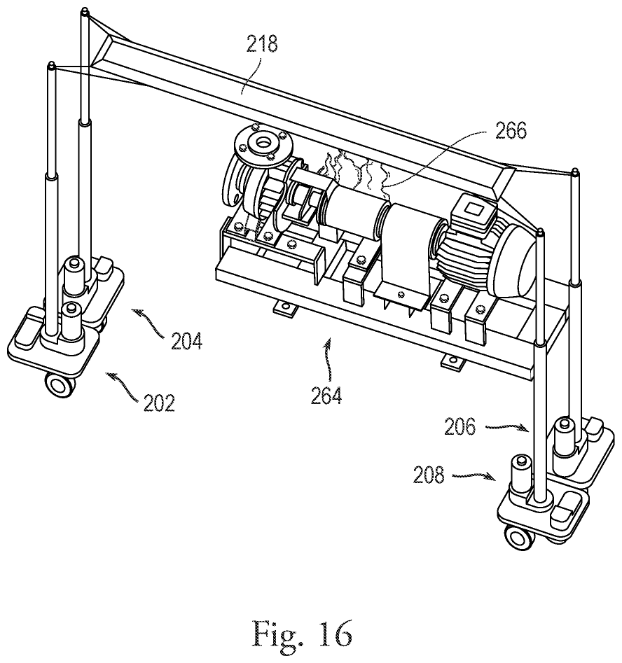

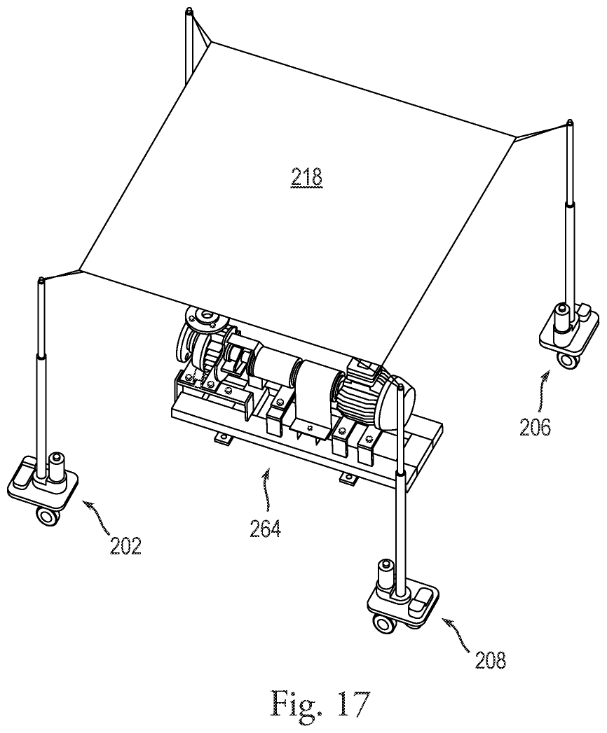

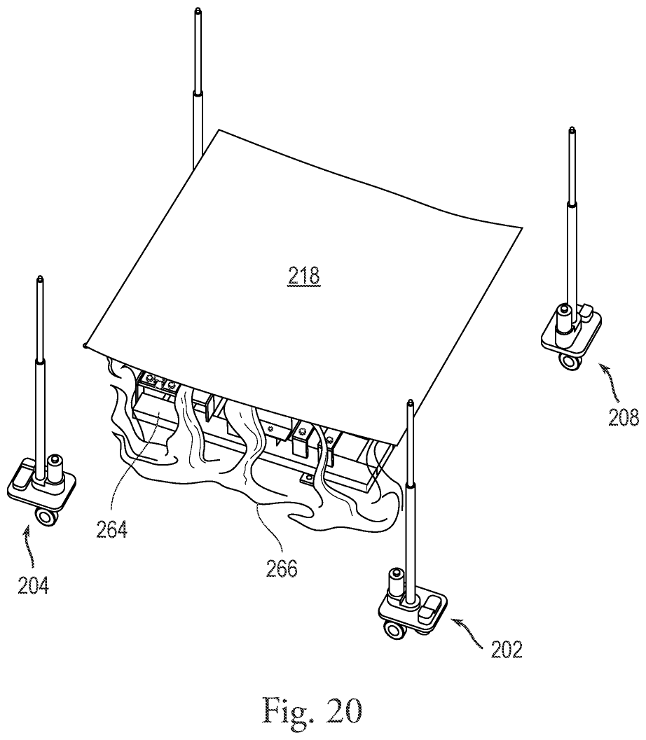

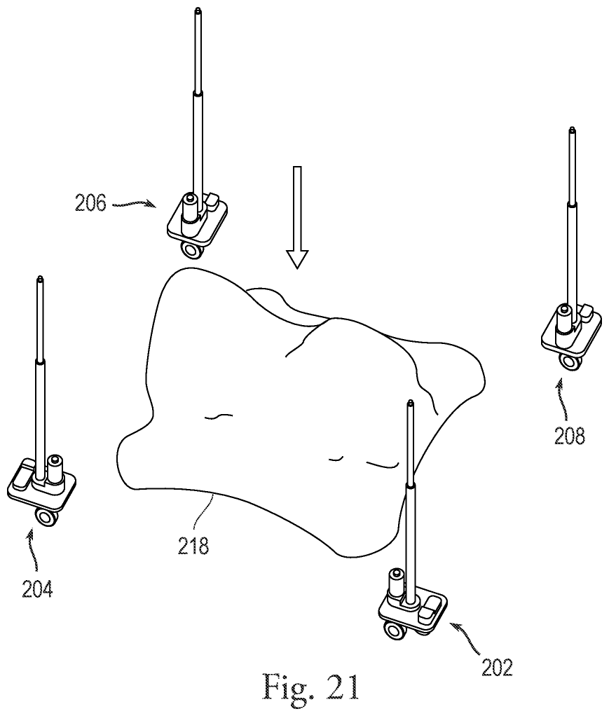

As shown in FIG. 15, the system 200 can be brought into proximity to equipment 264 which is on fire with flames 266. In one embodiment, the system 200 can be delivered near the equipment 264 by truck. Alternatively, the system 200 can travel using its mobile platforms 202, 204, 206, 208 to be in proximity to the equipment 264. As shown in FIG. 16, the mobile platforms 202, 204, 206, 208 are starting to be deployed around the equipment 264, with the mobile platforms 202, 204 split off from the mobile platforms 206, 208. Due to the splitting off of mobile platforms 202, 204, 206, 208, the fire blanket 218 starts to unfold. As shown in FIG. 17, the mobile platforms 202, 204, 206, 208 are further split apart to be in positions surrounding the equipment 264, such that the fire blanket 218 is completely in an unfolded configuration. As shown in FIGS. 17-18, the cap 260 retains the annular retaining member 262, and so the cables 220, 222, 224, 226 hold the unfolded fire blanket 218. As shown in FIG. 19, the cap 260 is then jettisoned or retracted to release the annular retaining member 262, and so the cables 220, 222, 224, 226 are loose, and the fire blanket 218 is free to fall. As shown in FIG. 20, the fire blanket 218 is falling onto the equipment 264 and flames 266 due to gravity. As shown in FIG. 21, the fire blanket 218 completely covers the equipment 264 and flames 266, to smother and extinguish the flames 266.

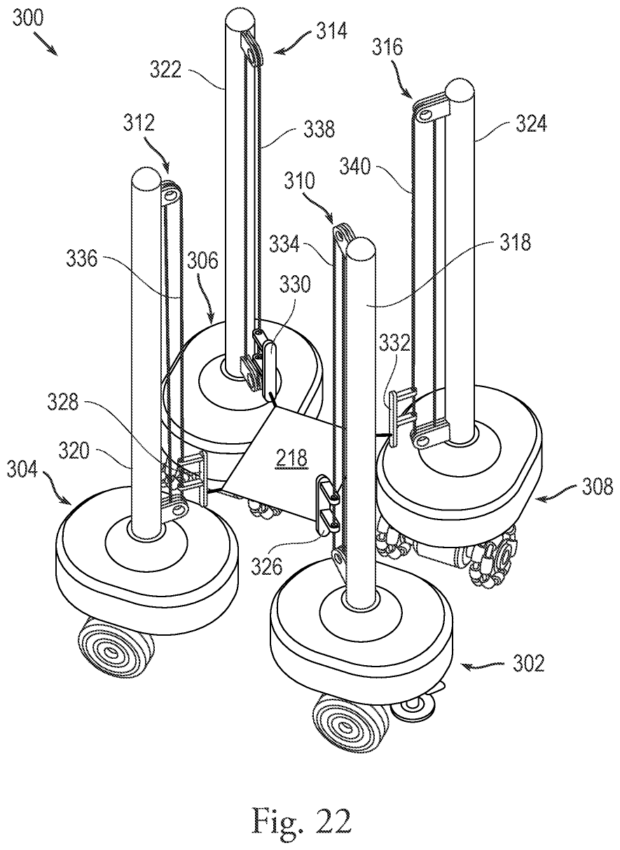

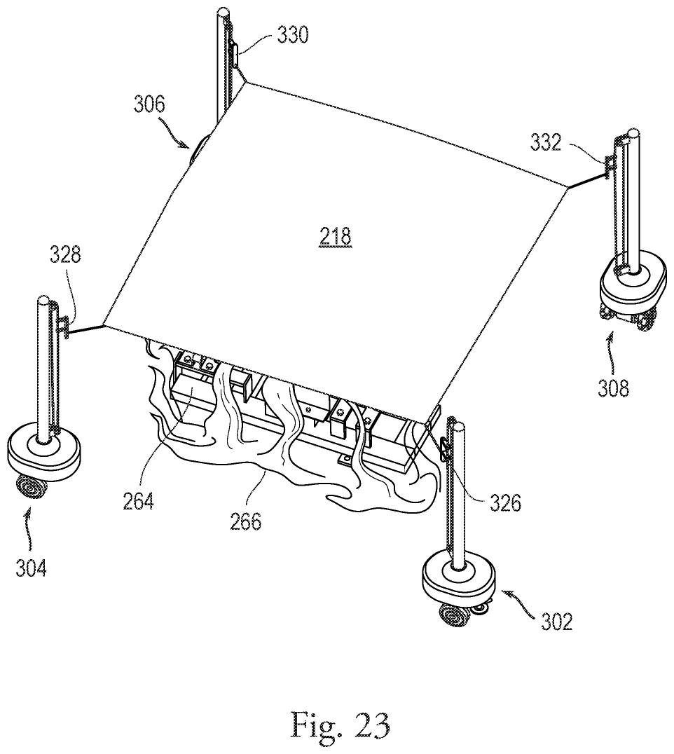

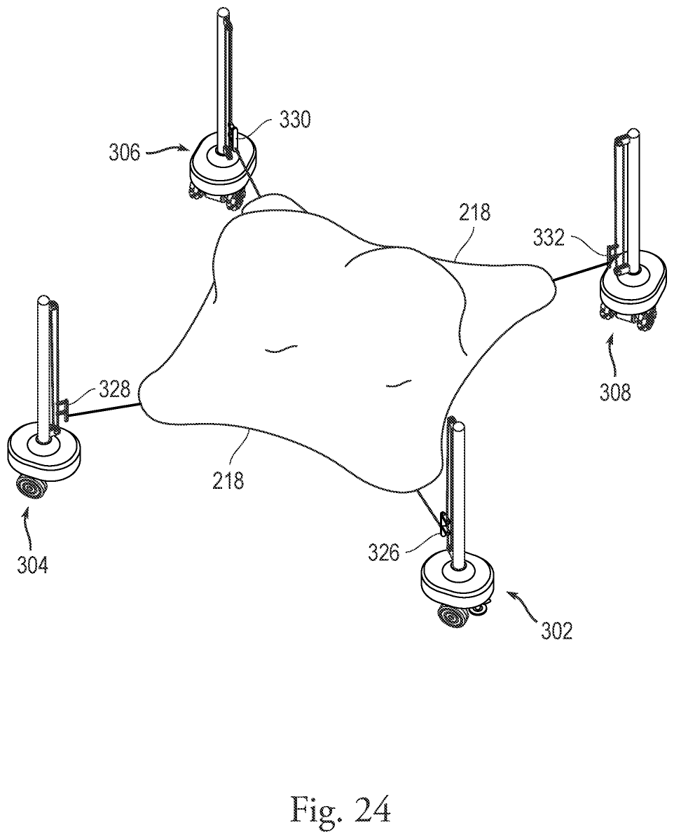

In an alternative embodiment shown in FIGS. 22-24, the system 300 has mobile platforms 302, 304, 306, 308, with each mobile platform 302, 304, 306, 308 having a pulley system 310, 312, 314, 316, respectively, mounted on poles 318, 320, 322, 324, respectively. The pulley systems 310, 312, 314, 316 are connected to the fire blanket 218 by cables attached to mounting brackets 326, 328, 330, 332, respectively. Each pulley system 310, 312, 314, 316 has a line 334, 336, 338, 340, respectively, extending and moving vertically along the length of the poles 318, 320, 322, 324, respectively. The mounting brackets 326, 328, 330, 332 attach the cables to the lines 334, 336, 338, 340, respectively. By using the pulley systems 310, 312, 314, 316, the system 300 can raise or lower the fire blanket 218 by moving the lines 334, 336, 338, 340, respectively. For example, after raising the fire blanket 218 and moving the mobile platforms 302, 304, 306, 308, as shown in FIG. 23, around the equipment 264 such that the fire blanket 218 is above the equipment 264 and the flames 266, the system 300 can then lower the fire blanket 218 onto the equipment 264 and the flames 266. The lowered fire blanket 218 then smothers and extinguishes the flames 266. The system 300 can then raise the fire blanket 218 off of the equipment 264, allowing the fire blanket 218 to be reused on another fire situation.

As shown in FIG. 22, the fire blanket 218 can be in a folded state. As shown in FIG. 23, the fire blanket 218 can be unfolded. Alternatively, the fire blanket 218 can be in a shrunken state as shown in FIG. 22, and the fire blanket 218 can be pulled or stretched by the mounting brackets 326, 328, 330, 332 on the poles 318, 320, 322, 324, respectively. By pulling or stretching the fire blanket 218, the fire blanket 218 can cover any size of equipment 264, and then smother and extinguish any size of flames 266.

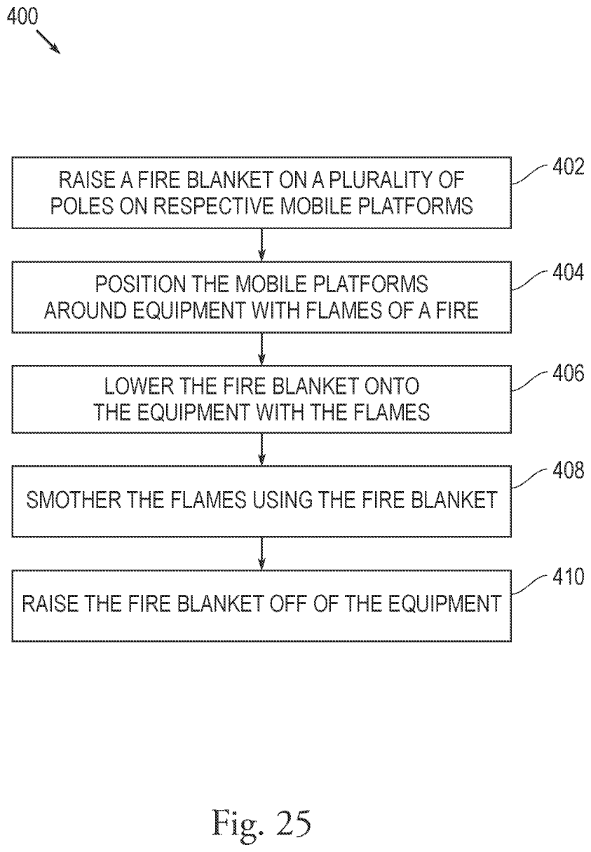

Referring to FIG. 25 in conjunction with FIGS. 12-24, a method 400 of operation of the systems 200, 300 can include the steps of raising a fire blanket 218 on a plurality of poles on respective mobile platforms in step 402. Then the mobile platforms are positioned around equipment with flames of a fire in step 404. The fire blanket 218 is lowered onto the equipment with the flames in step 406, and the fire blanket 218 smothers and extinguishes the flames in step 408. The fire blanket 218 is then raised off of the equipment in step 410. For example, in the embodiment shown in FIGS. 22-24, step 410 can be performed using the pulley systems 316, 318, 320, 322 to raise the fire blanket 218 off of the equipment 264 after the flames 266 of the fire are extinguished.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including.” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including.” “comprising,” “having,” “containing,” “involving.” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system configured to extinguish a fire, comprising:
a fire blanket;
a plurality of elongated members, each elongated member being connected to the fire blanket; and
a plurality of hinges, with each hinge pivotally coupling respective pairs of the plurality of elongated members,
wherein the plurality of elongated members are configured to lie horizontally on the ground so as to surround the fire in a first configuration,
wherein in a second configuration, a first opposing pair of elongated members are pivoted about the plurality of hinges with respect to a second opposing pair of elongated members to orient the first opposing pair vertically,
wherein the vertically oriented first opposing pair retain the fire blanket above the fire in the second configuration;
wherein the vertically oriented first opposing pair are pivoted to be oriented horizontally to return the plurality of elongated members to lie horizontally on the ground in the first configuration, and
wherein, responsive to the pivoting of the vertically oriented first opposing pair back to the first configuration, the fire blanket is positioned so as to lie over the fire proximate the ground, thereby smothering and extinguishing the fire.

2. The system of claim 1, wherein a set of the plurality of elongated members are arc-shaped.

3. The system of claim 2, wherein, with the plurality of elongated members in the first configuration, the set of arc-shaped elongated members are in a circular configuration surrounding the fire.

4. The system of claim 1, further comprising:
a cable coupled to the fire blanket; and
a winch disposed on the ground and configured to pull the cable along at least a first elongated member of the first opposing pair of elongated members in the second configuration, thereby deploying the fire blanket to be retained by the vertically oriented first opposing pair.

5. A system configured to extinguish a fire, comprising:
a fire blanket;
a plurality of mobile platforms;
a plurality of poles each extending vertically from a respective mobile platform; and
a plurality of cables,
wherein each pole is coupled to the fire blanket by a respective cable,
wherein the plurality of mobile platforms are movable to respective locations to surround the fire,
wherein each pole is configured to raise the fire blanket vertically above the fire, and
wherein the fire blanket is vertically lowerable to cover the fire, thereby smothering and extinguishing the fire.

6. The system of claim 5, wherein each pole includes a base member and a telescoping member movable vertically in the base member in a telescoping configuration.

7. The system of claim 5, wherein each mobility platform includes a wheel.

8. The system of claim 5, wherein each mobility platform includes ground lock member configured to lock the respective mobile platform in the respective location.

9. The system of claim 5, further comprising:
a plurality of caps each disposed at a top of a respective pole; and
a plurality of retaining members coupled to a respective cable,
wherein each cap retains a respective retaining member at the top of the respective pole.

10. The system of claim 9, wherein movement of each cap releases the respective retaining member, thereby letting the respective cable loose to lower the fire blanket by gravity.

11. The system of claim 10, wherein the movement of each cap includes jettisoning each cap from the top of each respective pole.

12. The system of claim 10, wherein the movement of each cap includes retracting each cap into the top of each respective pole.

13. The system of claim 5, further comprising:
a plurality of mounting brackets, with each bracket connected to the fire blanket by a respective cable;
a plurality of lines, with each line connected to a mounting bracket; and
a plurality of pulleys, with each pulley configured to move each respective line vertically,
wherein each pulley is associated with a respective pole, and
wherein each pulley is configured to raise or lower the fire blanket vertically by raising or lowering each respective line.

14. A method configured to extinguish a fire, comprising:
raising a fire blanket on a plurality of poles on respective mobility platforms;
positioning the plurality of mobility platforms around the fire;
lowering the fire blanket onto the fire; and
smothering the fire using the fire blanket, thereby extinguishing the fire.

15. The method of claim 14, further comprising:
raising the fire blanket after the fire is extinguished.

16. The method of claim 15, wherein the raising of the fire blanket includes:
raising the fire blanket using a plurality of pulley systems each attached to a respective pole.

17. The method of claim 14, wherein the raising of the fire blanket includes:
extending a telescoping member of each pole vertically.

18. The method of claim 14, further comprising:
disposing a plurality of caps at a top of each respective pole; and
retaining a plurality of cables at a top of each respective pole using a respective cap holding a respective retaining member,
wherein each cable is attached to the fire blanket by the respective retaining member.

19. The method of claim 18, further comprising:
releasing each respective retaining member by jettisoning each respective cap from the top of each respective pole.

20. The method of claim 18, further comprising:
releasing each respective retaining member by retracting each respective cap into the top of each respective pole.
